(19) United States
(12) Patent Application Publication
(10) Pub. No.: US 2007/0138760 A1
(43) Pub. Date: Jun. 21, 2007

(54) Retractable Boat Trailer

(76) Inventor: Richard Granzow, Frostproof, FL (US)

Correspondence Address: BOND, SCHOENECK & KING, PLLC, ONE LINCOLN CENTER, SYRACUSE, NY, 13202-1355, US

(21) Appl. No.: 11/164,461

(22) Filed: Nov. 23, 2005

(51) Int. Cl. B60D 1/54

(52) U.S. Cl. 280/491.2

(57) ABSTRACT

A retractable trailer having a telescoping tongue formed by an outer housing slidingly engaged over an inner sleeve. The inner sleeve is attached to a conventional hitch for engaging a towing vehicle and the outer housing is attached to the load bearing portion of the trailer. A threaded shaft is connected to a bearing in the rear of the outer housing and to a threaded receiver in the rear of the inner sleeve. The rear end of the shaft is interconnected to a two-way motor which operates off of the towing vehicles electrical system. Rotation of the shaft drives the outer housing axially with respect to the inner housing, thereby automatically telescoping the tongue to extend the length of the trailer.

### BACKGROUND OF THE INVENTION

1. Field of Invention

The present invention relates to trailers and, more specifically, to a retractable trailer for launching a boat.

2. Description of Prior Art

The conventional procedure for launching a boat from the rear of a towed trailer requires that the trailer be backed down the ramp of a boat launch. In order to place the boat in a position to be safely released, the trailer must be backed so far into the water that a portion of the towing vehicle becomes submerged. Submergence of the towing vehicle, however, can cause serious damage to the braking system and will encourage rusting of the vehicle.

While an extended length trailer would allow for release of the boat without having to back the towing vehicle into the water, a long trailer presents significant handling and safety issues when towed at speed over public roads. Some attempts to balance these concerns include the use of retractable trailers that may be extended for launching and retracted for traveling over the road. These designs are often mechanically complicated, thereby raising the costs of purchasing and operating such a trailer. Conventional retractable designs also rely on manually operated systems which require a boater to physically crank or winch the trailer between the extended and retracted positions. As a result, the cranking and telescoping mechanisms use multiple moving parts that add additional weight and complexity to the trailer design. These designs also rely on the telescoping mechanisms to maintain the trailer in the retracted position during travel, thereby degrading the hauling capacity and overall safety of the vehicle.

### Objects and Advantages

It is a principal object and advantage of the present invention to provide a telescoping trailer for more easily launching a boat.

It is an additional object and advantage of the present invention to provide a telescoping trailer that does not require manual exertion to move between retracted and extended positions.

It is a further object and advantage of the present invention to provide a telescoping trailer that is secure when towing over the road.

Other objects and advantages of the present invention will in part be obvious, and in part appear hereinafter.

### SUMMARY OF THE INVENTION

In accordance with the foregoing objects and advantages, the present invention comprises a trailer having a telescoping tongue which may be automatically extended to assist in the launching of a boat or other vehicle from the trailer. The trailer tongue comprises an outer housing connected to the load bearing portion of the trailer that is telescopically engaged with an inner sleeve connected to the hitch. A threaded shaft extends from a bearing at the rearward end of the outer housing and engages a corresponding threaded receiving element positioned in the rearward end of the inner sleeve. Rotation of the shaft by a motor advances or retracts the outer housing over the inner sleeve, thereby extending or retracting the trailer relative to the hitch.

### BRIEF DESCRIPTION OF THE DRAWINGS

The present invention will be more fully understood and appreciated by reading the following Detailed Description in conjunction with the accompanying drawings, in which:

FIG. 1 is an exploded perspective view of the present invention.

FIG. 2 is a top plan view with portions cut-away of the present invention.

FIG. 3 is a top plan view of another embodiment of the present invention.

### DETAILED DESCRIPTION

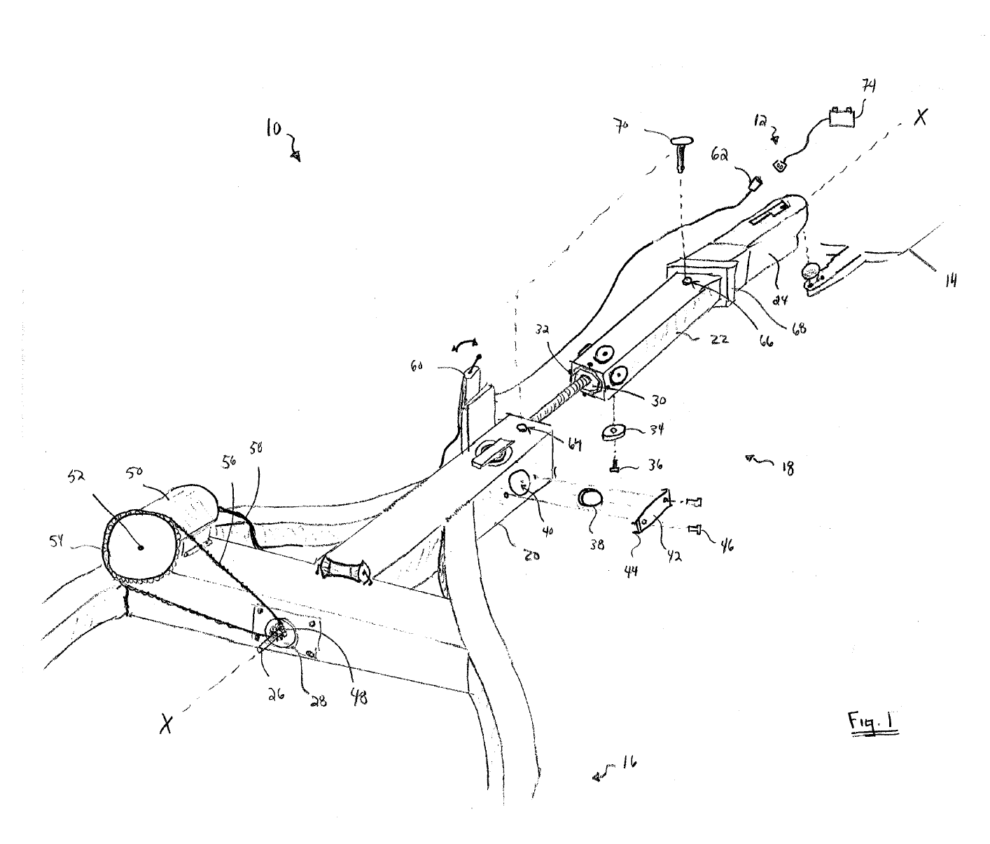

Referring to the drawings, wherein like numerals refer to like parts throughout, there is seen in FIG. 1 a retractable boat trailer 10 according to the present invention extending along axis X-X from a forward end 12 adapted for engaging the hitch of a tow vehicle 14 to a rearward end 16 adapted for carrying a load, such as a boat. Trailer 10 comprises a telescoping tongue 18 having an outer housing 20 extending along axis X-X and an inner sleeve 22 extending along X-X and positioned for telescopic movement into and out of the forward end of outer housing 20. Inner sleeve 22 may be welded to a conventional ball hitch 24, or other known apparatus for attaching to a tow vehicle 14. Outer housing 20 is connected to the load bearing portion 16 of trailer 10.

Outer housing 20 and inner sleeve 22 may be manufactured from conventional square rectangular steel tubing and are dimensioned to allow inner sleeve to easily slide into and out of outer housing 20. Outer housing 20 preferably has a dimension of about 4 inches and inner sleeve of about 3 inches.

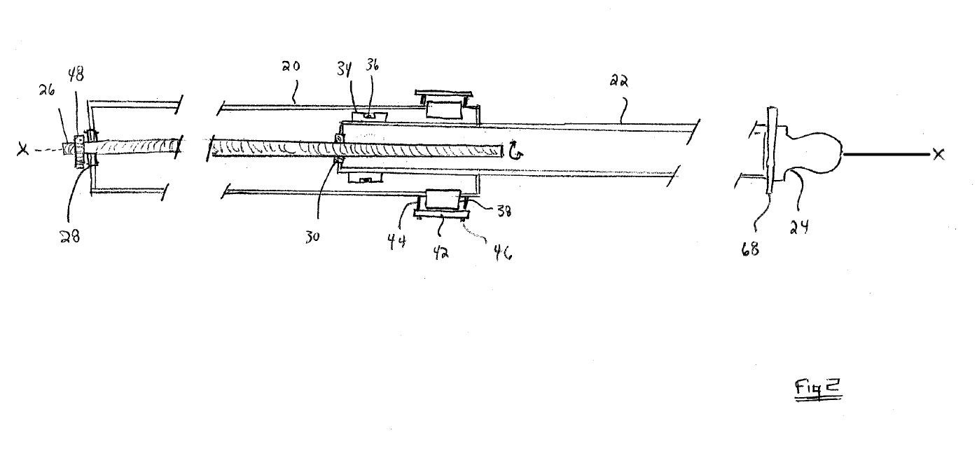

Referring to FIG. 2, telescoping inner sleeve 22 and outer housing 20 are interconnected by a threaded shaft 26 that is preferably about ½ inch to ⅝ inch in diameter. Rearward end of shaft 26 is connected to a bearing 28 rotatably positioned within the rearward end of outer housing 20 and extends along axis X-X inside outer housing 20. Forward end of shaft 26 is interconnected to the rearward end of inner sleeve 22 by a threaded receiving element 30. Receiving element 30 may comprise one or more nuts secured within inner sleeve by bolts 32 having a low profile head. As a result of the threaded engagement between shaft 26 and receiving element 30, rotation of shaft 26 will result in the forward or rearward movement of outer housing 20 along axis X-X, thereby telescoping over inner sleeve 22 and changes the effective length of trailer 10.

The outer surface of inner sleeve 22 may include one or more slider pads 34 attached thereto by a countersunk bolt 34 to maintain inner sleeve 22 in substantially concentric spaced relation within outer housing 20. Additional slider pads 38 may also be positioned in openings 40 formed in the forward end of outer housing 20. A cover plate 42 including spacer feet 44 is attached over openings 40 by bolts 46 to hold slider pads 38 into loose engagement with inner sleeve 22. Grease should be applied to inner sleeve 22 and slider pads 34 and 38 to reduce frictional forces when outer housing 20 telescopes over inner sleeve 22.

Rearward end of shaft 26 includes a shaft gear 48 for interconnection to a two-way motor 50 positioned on trailer 10. Motor 50 includes a drive shaft 52, a drive gear 54 connected to shaft 52, and a chain 56 for connecting drive gear 54 to shaft gear 40. The ratio of the gear 54 and 48 may be varied, depending on the towing capacity of trailer 10 and the power rating of motor 50. Motor 50 is electrically interconnected by wires 58 to a two-way switch 60 mounted on the forward end of outer housing 20 and adapted for controlling the operation of motor 50 in both directions. Switch 60 may interconnected to the electrical system 74 of the towing vehicle 14 via a conventional electrical power takeoff plug 62. Alternatively, switch 60 (and motor 50) may be powered by an auxiliary electrical system, such as an additional battery or an on-board generator. Motor 50 preferably comprises a 110 Watt electric two-way motor.

For securely transporting a load, forward portion of outer housing 20 may include opposing holes 64 formed through its upper and lower surfaces that align with correspondingly sized opposing holes 66 formed through the upper and lower surfaces of the forward portion of inner sleeve 22. When outer housing 20 is fully retracted over inner sleeve 22, the forward end of outer housing 20 engages a stop 68 positioned around the forward end of inner sleeve 22. A hitch pin 70 may then be inserted through corresponding holes 64 and 66 to retain outer housing 20 in position over inner sleeve 22.

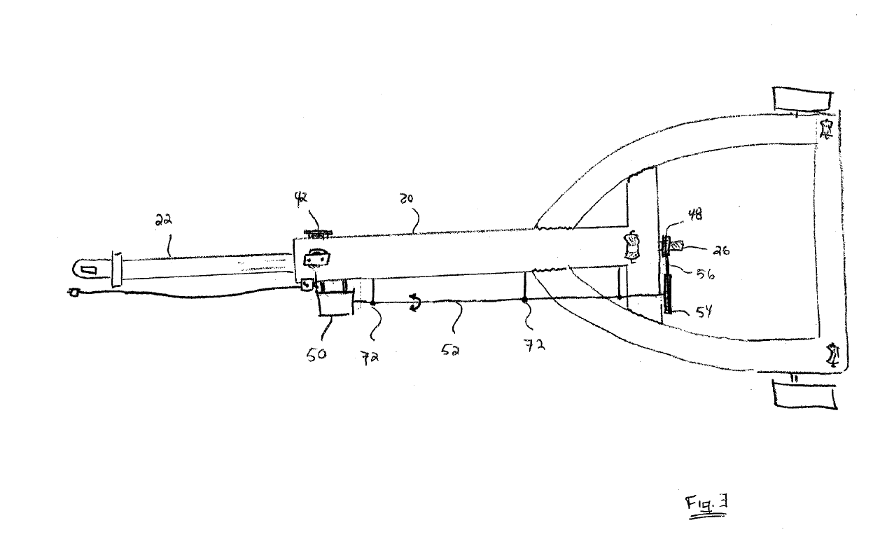

Referring to FIG. 3, motor 50 may be positioned on the forward end of outer housing 20. In this embodiment, drive shaft 52 extends longitudinally along an axis parallel to X-X and is connected to drive gear 54 at the rearward end of tongue 18. Pillow block bearings 72 may be spaced apart and mounted along the side of outer housing 20 to support elongated drive shaft 52.

Operation of trailer 10 to launch a boat begins by backing trailer 10 down a dock ramp. Vehicle 14 may be parked above the water line of the ramp. After removing hitch pin 70 from holes 64 and 66, switch 60 is activated to operate motor 50 in a direction which extends telescoping tongue 18. When outer housing 20 has telescoped off of inner sleeve 22 sufficiently far enough to place the boat into the water, switch 60 is returned to the off position and the boat is released from trailer 10. When the boat is returned to trailer and winched aboard through convention means, the procedure may then be reversed. Switch 60 is activated in the opposite direction to fully retract outer housing 20 over inner sleeve 22, and hitch pin 70 is replaced in holes 64 and 66 to secure trailer 10 for highway travel.

What is claimed is:

1. A retractable trailer, comprising:
a tongue including an outer housing in telescopic engagement with an inner sleeve; and
a threaded shaft having a first end interconnected to said outer housing and a second end interconnected to said inner sleeve, wherein rotation of said shaft results in axial movement of said outer housing relative to said inner housing.

2. The trailer of claim 1, further comprising:
a bearing positioned in said outer housing and connected to said shaft; and
a receiver positioned in said inner housing and threadably engaged with said shaft.

3. The trailer of claim 2, further comprising:
a shaft gear mounted on said first end of said shaft;
a motor positioned on said trailer having a drive gear interconnected to said shaft gear.

4. The trailer of claim 3, further comprising a hitch mounted to said inner sleeve.

5. The trailer of claim 4, further comprising at least one slider pad mounted to said inner sleeve for slidingly engaging said outer housing.

6. The trailer of claim 5, further comprising at least a second slider pad mounted within a hole formed in said outer housing for slidingly engaging said inner sleeve.

7. The trailer of claim 6, further comprising a switch interconnecting said motor with an electrical power source.

8. The trailer of claim 7, further comprising a first pair of holes formed through said outer housing and a second pair of holes formed through said inner sleeve, whereby said first pair of holes is aligned with said second pair of holes when said outer housing is fully retracted over said inner sleeve.

9. The trailer of claim 8, wherein said motor is positioned proximate to said first end of said shaft.

10. The trailer of claim 8, wherein said motor is positioned proximate to said hitch and said drive shaft extends the length of said tongue.

11. The trailer of claim 10, further comprising a pillow block bearing supporting said drive shaft.

12. A retractable trailer, comprising:
a tongue having a forward end connected to a hitch and a rearward end connected to a load-bearing portion, said tongue including an outer housing in telescopic engagement with an inner sleeve;
a threaded shaft having a first end extending through and connected to a bearing positioned in the rearward end of said tongue and a second end interconnected to said inner sleeve by a threaded receiver, wherein rotation of said shaft results in axial movement of said outer housing relative to said inner housing;
a shaft gear mounted on said first end of said shaft;
a two-way motor mounted on said trailer and including gear shaft interconnected to a drive gear;
a chain connecting said shaft gear to said drive gear; and
a switch interconnecting said motor to a power source for selective operating said motor in either direction.

13. The trailer of claim 12, further comprising at least a first slider pad mounted on said inner sleeve for slidingly engaging said outer housing, and at least a second slider pad mounted in a hole formed through said outer housing for slidingly engaging said inner sleeve.

14. The trailer of claim 13, further comprising:
a first pair of holes formed through said outer housing;
a second pair of holes formed through said inner sleeve, wherein said first pair of holes are aligned with said second pair of holes when said outer housing is fully retracted over said inner sleeve; and
a hitch pin removably positioned through said first pair of holes and said second pair of holes.
